(19) United States
(12) Patent Application Publication
(10) Pub. No.: US 2009/0120860 A1
(43) Pub. Date: May 14, 2009

(54) Water aerating and dirt collecting assembly for aquarium

(76) Inventor: Hsueh-Lee Tsai, Yunlin Hsien (TW)

Correspondence Address: CHARLES E. BAXLEY, ESQUIRE, 90 JOHN STREET, SUITE 309, NEW YORK, NY, 10038, US

(21) Appl. No.: 12/148,932

(22) Filed: Apr. 22, 2008

Related U.S. Application Data
(63) Continuation-in-part of application No. 11/985,446, filed on Nov. 14, 2007.

(51) Int. Cl. A01K 63/04

(52) U.S. Cl. 210/167.26; 210/167.27

(57) ABSTRACT

A water aerating and dirt collecting device for an aquarium includes a pumping device having a paddle device for pumping and circulating the water contained within the aquarium, a receptacle having a three housing members coupled to the pumping device, a vessel disposed on an upper housing member and having a tubular member for forming a peripheral chamber and for allowing an air bubble and a dirt to flow upwardly through the tubular member and to be collected in the peripheral chamber of the vessel, a cap attached to the vessel and having an exit coupled to a dirt collector for collecting the dirt, and having a mouth coupled to the pumping device for vacuuming purposes.

The present invention is a continuation-in-part of U.S. patent application Ser. No. 11/985,446, filed 14 Nov. 2007, pending.

### BACKGROUND OF THE INVENTION

1. Field of the Invention

The present invention relates to a water aerating and dirt collecting assembly for an aquarium, and more particularly to a water aerating and dirt collecting assembly for attaching to an aquarium and for suitably agitating the water and the carbon dioxide and for suitably supplying the air and/or the carbon dioxide into the water contained within the container and for suitably filtering and collecting the dirt contained within the water of the container.

2. Description of the Prior Art

Typical aquarium facilities comprise a pump disposed in a chamber of a container for circulating the water contained within the container and for pumping fresh air or carbon dioxide into the container and thus for airing or aerating purposes.

For example, U.S. Pat. No. 6,857,392 to Shyu discloses one of the typical aquarium pumping and airing apparatuses comprising a pump including a paddle device coupled to a rotor for being operated to pump and to circulate the water contained within the container.

However, the typical aquarium pumping and airing apparatus has no water aerating and dirt collecting assemblies for suitably separating and collecting the dirt contained within the container and the dirt may remain or may still be contained within the container and may not be removed from the container.

U.S. Pat. No. 7,011,748 to Tsai discloses another typical aerating and dirt collecting assembly for an aquarium and also comprising a paddle wheel for agitating the water and/or the air and for pumping the air and/or the carbon dioxide into the water of the container and for generating bubbles to collect the dirt or the protein or the like contained in the bubbles.

However, the carbon dioxide may not be suitably agitated and may not be suitably supplied into the water contained within the container.

The present invention has arisen to mitigate and/or obviate the afore-described disadvantages of the conventional water aerating and dirt collecting assemblies for aquarium facilities.

### SUMMARY OF THE INVENTION

The primary objective of the present invention is to provide a water aerating and dirt collecting assembly for attaching to an aquarium and for suitably agitating the water and the carbon dioxide and for suitably supplying the carbon dioxide into the water contained within the container and for suitably filtering and collecting the dirt contained within the water of the container.

In accordance with one aspect of the invention, there is provided a water aerating and dirt collecting assembly for an aquarium comprising a pumping device for attaching to a container of the aquarium, and including a casing provided on top of the pumping device and having a chamber formed in the casing, and including a paddle device for pumping and circulating a water, a receptacle including a lower housing member coupled to the casing of the pumping device, a middle housing member attached to the lower housing member, and an upper housing member attached to the middle housing member, the middle housing member including at least one inlet opening directed toward the casing for allowing the water contained in the container to flow into the middle housing member and to flow toward the casing and to be pumped by the paddle device, and the paddle device being arranged to pump the water up through the middle housing member and toward the upper housing member, a filter member disposed in the upper housing member for filtering the water, the upper housing member including at least one outlet opening for directing the water filtered by the filter member to flow out to the container, a vessel disposed on the upper housing member and including a tubular member for forming a peripheral chamber between the tubular member and the vessel, and the tubular member being arranged for receiving the water and for allowing an air bubble and a dirt to flow upwardly through the tubular member of the vessel and to be collected in the peripheral chamber of the vessel, a cap attached to the vessel to close the vessel, and the cap including an exit communicating with the peripheral chamber of the vessel and coupled to a pipe for allowing the dirt collected in the peripheral chamber of the vessel to flow out through the exit of the cap and to flow out through the pipe, a dirt collector including a housing for collecting the dirt, and including an inlet port coupled to the pipe for allowing the dirt to flow through the pipe and to flow into the housing and to be collected in the housing, and including a mouth, and a hose coupled to the mouth of the housing and directed toward the pumping device for allowing an air contained in the housing to be vacuumed and drawn into the pumping device with the paddle device and for drawing the dirt from the peripheral chamber of the vessel to the housing.

The dirt collector includes a cover attached to the housing to close the housing, and the inlet port and the mouth are formed in the cover. The receptacle may be attached to the container with one or more sucking cups.

The vessel includes an air channel formed therein for allowing the air to flow into the vessel and to flow out through the exit and to flow into the pipe and to flow into the housing of the dirt collecting device.

The receptacle includes a box disposed into the upper housing member for receiving the water from the middle housing member, the filter member is disposed on the box, and the box includes a hole formed therein for guiding the water to flow to the filter member.

The box includes at least one fin extended upwardly from the box and arranged around the hole of the box for forming at least one path, the filter member is disposed around the fin.

The upper housing member includes a bottom board having a passageway formed in the bottom board for allowing the water to flow into the upper housing member.

The middle housing member includes a tube extended in the middle housing member and includes a bore formed in the middle housing member and formed in the tube and communicating with the outlet opening of the upper housing member for receiving the water from the chamber of the container.

The middle housing member includes a space formed outside the tube for receiving the water impelled by the paddle device and for allowing the water to flow upwardly through the space and to flow out of the middle housing member and to flow into the upper housing member.

A guide tubing may further be provided and coupled between the bore of the middle housing member and the casing for guiding the water to flow into the casing and to be impelled by the paddle device.

The guide tubing includes at least one projection extended out of the guide tubing for forming at least one passage and for allowing the water impelled by the paddle device to flow out through the passage and to flow out of the casing.

The middle housing member includes a cap disposed on top of the tube for blocking the tube and for limiting the water to flow into the casing only, and for preventing the water from flowing upwardly and out of the tube.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a cross sectional view illustrating the operation of a water aerating and dirt collecting assembly in accordance with the present invention;

FIG. 2 is an exploded view of the water aerating and dirt collecting assembly;

FIG. 3 is a bottom perspective view illustrating a receptacle of the water aerating and dirt collecting assembly;

FIG. 4 is a perspective view of the water aerating and dirt collecting assembly; and

FIG. 5 is a cross sectional view of the water aerating and dirt collecting assembly taken along lines 5-5 of FIG. 4.

### DETAILED DESCRIPTION OF THE PREFERRED EMBODIMENT

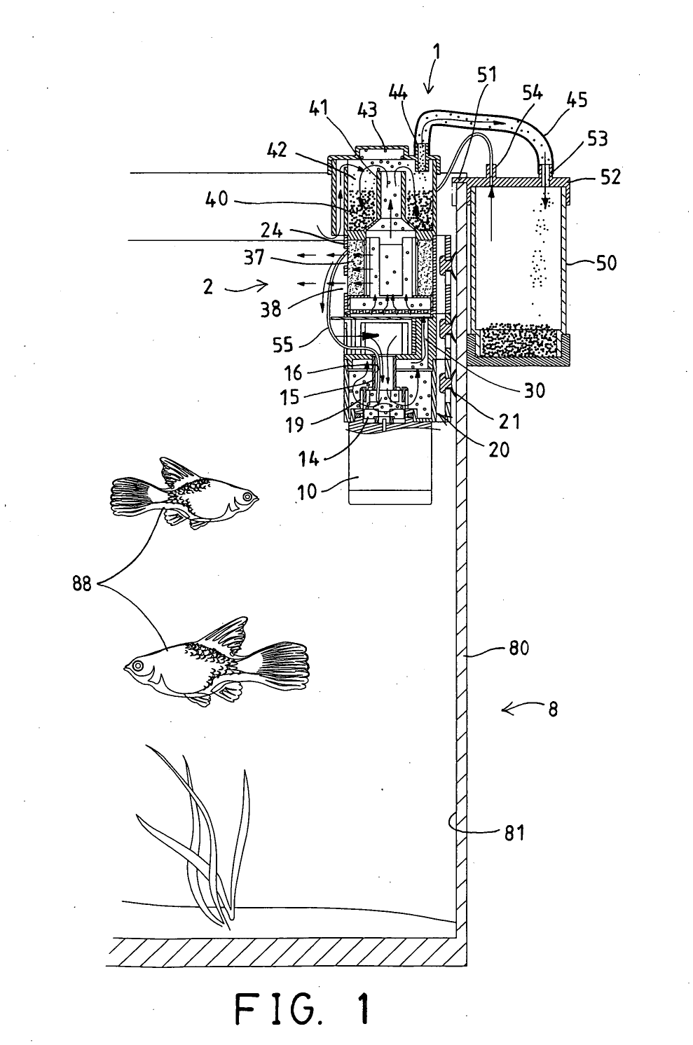

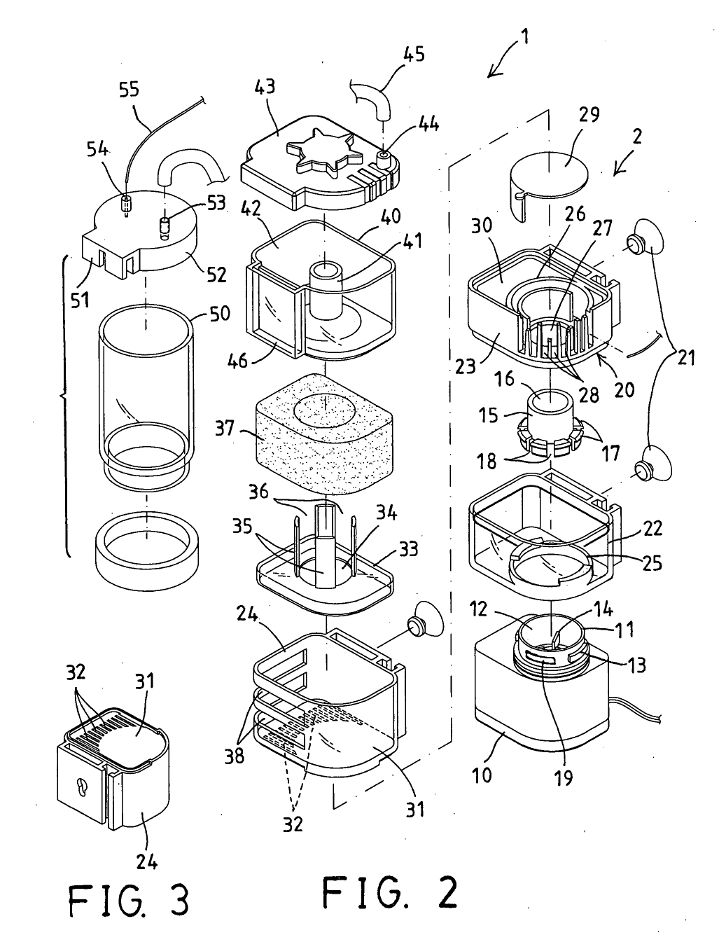

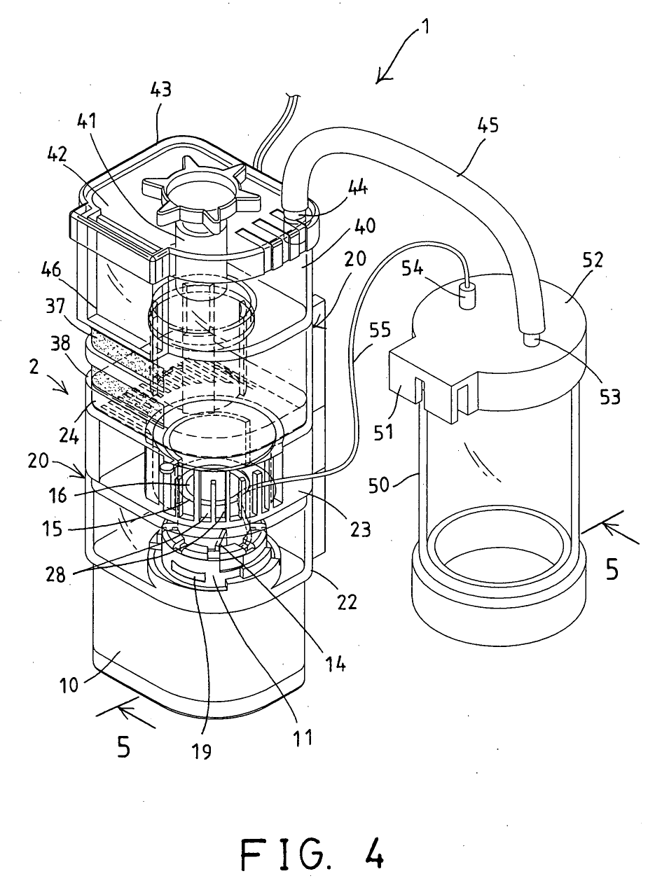

Referring to the drawings, and initially to FIGS. 1-3, a water aerating and dirt collecting assembly 1 in accordance with the present invention is provided for attaching to an aquarium 8 which comprises a container 80 including a chamber 81 formed therein for receiving water and fish 88, and comprises a pumping device 10 for attaching to the interior of the container 80 with hooks or latches or fasteners or sucking cups (not shown) or the like, the pumping device 10 includes a casing 11 formed or provided on top or on the upper portion thereof and having a chamber 12 formed in the casing 11, and includes a powered or motorized impeller or paddle wheel or paddle device 14 for pumping the water and/or the air and for circulating the water and/or the air contained within the container 80.

A guide tubing 15 is engaged into the casing 11 and includes a bore 16 formed therein for guiding the water to flow into the casing 11 (FIG. 1) and for allowing the water to be pumped or impelled by the paddle device 14, and includes one or more projections 17 extended radially and outwardly from the guide tubing 15 for forming one or more slots or passages 18 between the projections 17 and for allowing the water pumped or impelled by the paddle device 14 to flow out through the passages 18 between the projections 17 and to flow out of the casing 11 (FIG. 1). The casing 11 may include one or more pathways 19 formed therein and aligned with the passages 18 between the projections 17 for allowing the water to flow out of the casing 11.

The water aerating and dirt collecting assembly 1 further includes a protein separating device 2 having a receptacle 20 for attaching to the interior of the container 80 with hooks or latches or fasteners (not shown) or sucking cups 21 or the like, the receptacle 20 may include one or more (such as three) housing members 22, 23, 24 assembled or secured or coupled together with such as force-fitted engagements, hooks or latches or fasteners (not shown) or with adhesive materials, or by welding processes, and may include an entrance 25 formed or provided in such as the lower portion thereof or the lower housing member 22 for receiving the casing 11, and for securing the casing 11 and the lower housing member 22 together with locks or latches 13, and for allowing the casing 11 to be extended into the lower housing member 22.

The receptacle 20 may include a tube 26, such as a three-quarter tube 26 extended in the middle housing member 23, and includes a bore 27 formed in the middle housing member 23, such as formed in the inner portion of the tube 26 for receiving or engaging with the upper portion of the guide tubing 15, and for allowing the guide tubing 15 to be disposed and arranged or coupled between the bore 27 of the middle housing member 23 and the guide tubing 15, and includes one or more inlet openings 28 formed in such as the outer peripheral portion of the middle housing member 23 and communicating with the chamber 81 of the container 80 and also communicating with the tube 26 and the bore 27 of the middle housing member 23 and the guide tubing 15, and for allowing the water to flow into the guide tubing 15 and then to flow into the casing 11 and to be pumped or impelled by the paddle device 14.

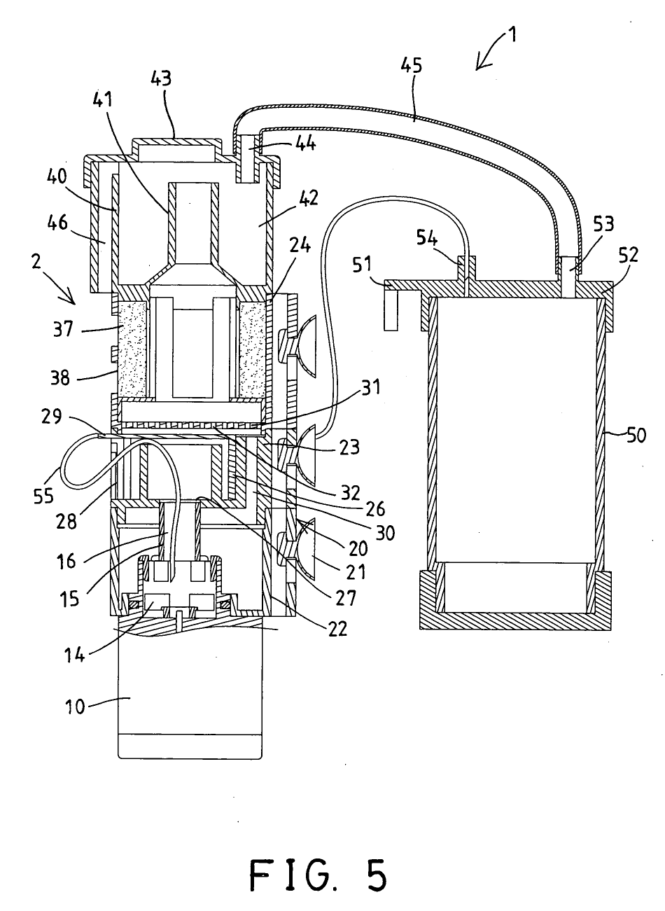

A cap 29 may be disposed on top of the tube 26 for blocking the tube 26 (FIG. 5) and for limiting the water to flow into the casing 11 only, and for preventing the water from flowing upwardly and out of the tube 26. The middle housing member 23 may include a space 30 formed outside the tube 26 for receiving the water pumped or impelled by the paddle device 14 and for allowing the water to flow upwardly and to flow out of the middle housing member 23 and then to flow into the upper housing member 24 (FIG. 1). The upper housing member 24 may include a bottom board 31 having a number of slots or passageways 32 formed therein and aligned with or communicating with the space 30 of the middle housing member 23 for allowing the water to flow into the upper housing member 24.

A box 33 is disposed or engaged into the upper housing member 24 and includes a hole 34 formed therein for guiding the water to flow from the passageways 32 of the bottom board 31 and to flow out through the hole 34 of the box 33, and includes one or more fins 35 extended upwardly from the box 33 and located or arranged around the hole 34 of the box 33 for forming one or more gaps or paths 36 between the fins 35. A filter sponge or member 37 may be disposed in the upper housing member 24 and disposed on the box 33 and disposed around the fins 35 for filtering the water and for separating the dirt or the protein from the water and thus for preventing the filtered dirt or protein from flowing into the chamber 81 of the container 80 again.

The upper housing member 24 includes one or more outlet openings 38 formed in such as the outer peripheral portion of the upper housing member 24 for allowing the water filtered by the filter sponge or member 37 to flow out of the upper housing member 24 and to flow into the chamber 81 of the container 80 again. A vessel 40 is disposed or secured on top of the upper housing member 24 of the receptacle 20, and includes a tubular member 41 extended in the inner portion thereof for forming an annular or peripheral chamber 42 between the tubular member 41 and the vessel 40, and the tubular member 41 is disposed and arranged above the fins 35 and the hole 34 of the box 33 for allowing the water or the air bubbles and the dirt or the contaminant to flow upwardly through the tubular member 41.

When the water flows through the passageways 32 of the bottom board 31 and flows out through the hole 34 of the box 33, the water may be agitated to form or to generate an eddy current and to suitably separate the dirt or the protein contained within the water and/or for suitably agitating the water and the carbon dioxide and/or the air contained within the water and for allowing the carbon dioxide and/or the air to be suitably agitated or minimized into a large amount of smaller air bubbles that may be caused to flow upwardly through the tubular member 41 (FIG. 1), the dirt or the protein may then be moved over the tubular member 41 and may have a good chance to be collected in the lower portion of the peripheral chamber 42 of the vessel 40.

A cap 43 is openably attached on top of the vessel 40 to selectively close the vessel 40, and include an exit 44 formed or provided in such as the upper portion thereof and preferably communicating with the peripheral chamber 42 for allowing the dirt or the protein collected in the peripheral chamber 42 of the vessel 40 to flow out through the exit 44 of the cap 43 and to flow into a pipe 45. The vessel 40 may include one or more air channels 46 formed therein for allowing the air to flow into the vessel 40 and to selectively flow out through the exit 44 and to flow into the pipe 45 and to flow into a dirt collecting device which will be discussed hereinafter.

The water aerating and dirt collecting assembly 1 further includes a dirt collector 5 having a housing 50 for attaching to the interior of the container 80 with hooks or latches or fasteners or sucking cups (not shown) or the like, or may include a hook 51 for attaching or hanging onto the container 80, and may include a cover 52 openably attached on top of the housing 50 to selectively enclose the housing 50, and may include an inlet port 44 formed or provided in such as the upper portion of the housing 50 or formed in the cover 52, and coupled to the pipe 45 for allowing the dirt or the protein collected in the peripheral chamber 42 of the vessel 40 to flow through the pipe 45 and to flow into the housing 50 and thus to be collected in the housing 50.

The housing 50 may further include a mouth 54 formed or provided in such as the upper portion of the housing 50 or formed in the cover 52, and coupled to a hose 55 which is engaged into the guide tubing 15 and directed toward the pumping device 10 for allowing the air contained in the upper portion of the housing 50 to be vacuumed or pumped or sucked or drawn into the pumping device 10 with or by the motorized paddle wheel or paddle device 14. When the air contained in the upper portion of the housing 50 is vacuumed or pumped or sucked or drawn into the pumping device 10, the housing 50 may be selectively vacuumed, or the dirt or the protein collected in the peripheral chamber 42 of the vessel 40 may be suitably drawn to flow through the pipe 45 and to flow into the housing 50 and thus to be collected in the housing 50.

It is to be noted that the filtered dirt or protein may be filtered and separated from the water by the filter sponge or member 37, and the filtered water may flow into the chamber 81 of the container 80 to prevent the filtered dirt or protein from flowing into the chamber 81 of the container 80 again. The fresh air may flow through the air channels 46 of the vessel 40 and may flow into the vessel 40 and may be drawn to flow through the pipe 45 and to flow into the housing 50 and then to flow through the hose 55 and to flow into the pumping device 10 and thus for allowing the fresh air to be suitably supplied into the water contained within the container 80. It is preferable that the tubular member 41 of the vessel 40 is arranged to allow only the filtered dirt or protein to move over the tubular member 41 and to be collected in the lower portion of the peripheral chamber 42 of the vessel 40.

Accordingly, the water aerating and dirt collecting assembly in accordance with the present invention may be provided for attaching to an aquarium and for suitably agitating the water and the carbon dioxide and for suitably supplying the carbon dioxide into the water contained within the container and for suitably filtering and collecting the dirt contained within the water of the container.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A water aerating and dirt collecting assembly for an aquarium comprising:
a pumping device for attaching to a container of the aquarium, and including a casing provided on top of said pumping device and having a chamber formed in said casing, and including a paddle device for pumping and circulating a water,
a receptacle including a lower housing member coupled to said casing of said pumping device, a middle housing member attached to said lower housing member, and an upper housing member attached to said middle housing member, said middle housing member including at least one inlet opening directed toward said casing for allowing the water contained in said container to flow into said middle housing member and to flow toward said casing and to be pumped by said paddle device, and said paddle device being arranged to pump the water up through said middle housing member and toward said upper housing member,
a filter member disposed in said upper housing member for filtering the water,
said upper housing member including at least one outlet opening for directing the water filtered by said filter member to flow out to said container,
a vessel disposed on said upper housing member and including a tubular member for forming a peripheral chamber between said tubular member and said vessel, and said tubular member being arranged for receiving the water and for allowing an air bubble and a dirt to flow upwardly through said tubular member of said vessel and to be collected in said peripheral chamber of said vessel,
a cap attached to said vessel to close said vessel, and said cap including an exit communicating with said peripheral chamber of said vessel and coupled to a pipe for allowing the dirt collected in said peripheral chamber of said vessel to flow out through said exit of said cap and to flow out through said pipe,
a dirt collector including a housing for collecting the dirt, and including an inlet port coupled to said pipe for allowing the dirt to flow through said pipe and to flow into said housing and to be collected in said housing, and including a mouth, and
a hose coupled to said mouth of said housing and directed toward said pumping device for allowing an air contained in said housing to be vacuumed and drawn into said pumping device with said paddle device and for drawing the dirt from said peripheral chamber of said vessel to said housing.

2. The water aerating and dirt collecting assembly as claimed in claim 1, wherein said dirt collector includes a cover attached to said housing to close said housing, and said inlet port and said mouth are formed in said cover.

3. The water aerating and dirt collecting assembly as claimed in claim 2, wherein said vessel includes an air channel formed therein for allowing the air to flow into said vessel and to flow out through said exit and to flow into said pipe and to flow into said housing of said dirt collecting device.

4. The water aerating and dirt collecting assembly as claimed in claim 1, wherein said receptacle includes a box disposed into said upper housing member for receiving the water from said middle housing member, said filter member is disposed on said box, and said box includes a hole formed therein for guiding the water to flow to said filter member.

5. The water aerating and dirt collecting assembly as claimed in claim 4, wherein said box includes at least one fin extended upwardly from said box and arranged around said hole of said box for forming at least one path, said filter member is disposed around said at least one fin.

6. The water aerating and dirt collecting assembly as claimed in claim 1, wherein said upper housing member includes a bottom board having a passageway formed in said bottom board for allowing the water to flow into said upper housing member.

7. The water aerating and dirt collecting assembly as claimed in claim 6, wherein said middle housing member includes a tube extended in said middle housing member and includes a bore formed in said middle housing member and formed in said tube and communicating with said at least one outlet opening of said upper housing member for receiving the water from said chamber of said container.

8. The water aerating and dirt collecting assembly as claimed in claim 7, wherein said middle housing member includes a space formed outside said tube for receiving the water impelled by said paddle device and for allowing the water to flow upwardly through said space and to flow out of said middle housing member and to flow into said upper housing member.

9. The water aerating and dirt collecting assembly as claimed in claim 7, wherein a guide tubing is coupled between said bore of said middle housing member and said casing for guiding the water to flow into said casing and to be impelled by said paddle device.

10. The water aerating and dirt collecting assembly as claimed in claim 9, wherein said guide tubing includes at least one projection extended out of said guide tubing for forming at least one passage and for allowing the water impelled by said paddle device to flow out through said at least one passage and to flow out of said casing.

11. The water aerating and dirt collecting assembly as claimed in claim 7, wherein said middle housing member includes a cap disposed on top of said tube for blocking said tube and for limiting the water to flow into said casing only, and for preventing the water from flowing upwardly and out of said tube.

12. The water aerating and dirt collecting assembly as claimed in claim 1, wherein said receptacle is attached to said container with at least one sucking cup.
